(19) United States
(12) Patent Application Publication
(10) Pub. No.: US 2007/0242839 A1
(43) Pub. Date: Oct. 18, 2007

(54) REMOTE WIRELESS MICROPHONE SYSTEM FOR A VIDEO CAMERA

(76) Inventors: Stanley Kim, San Diego, CA (US); Brian Morneyer, San Diego, CA (US)

Correspondence Address: WILLIAM J. KOLEGRAFF, 3119 TURNBERRY WAY, JAMUL, CA, 91935, US

(21) Appl. No.: 11/279,744

(22) Filed: Apr. 13, 2006

(51) Int. Cl. H04R 3/00; H04R 1/02

(52) U.S. Cl. 381/122; 381/91; 381/113

(57) ABSTRACT

A wireless audio receiver is provided that couples to a video camera using a standard audio connector. This enables a wide range of legacy and non-wireless video cameras to receive sound information through a wireless connection. The wireless audio receiver may be paired with a remote wireless microphone, and receive a wireless signal having sound information captured at the remote location. In one example, the wireless audio receiver is constructed with a Bluetooth compliant radio system. The wireless audio receiver may connected to an audio-in port of the camera using a connection cable, or the wireless audio receiver may be constructed so that the standard connector provides both mechanical and electrical connections.

### FIELD OF THE INVENTION

The present invention relates to capturing sound information for video camera applications. More particularly, the invention relates to using a wireless remote microphone coupled to a video camera using a standard audio input jack widely found on video cameras.

### BACKGROUND

Portable video cameras, often referred to as camcorders, are a popular consumer item. These cameras have enabled capture and recording of sporting, family, and other events in a convenient manner. These cameras are small, light, portable, and typically powered by rechargeable batteries. There are a number of different types of camcorders using a multitude of proprietary and standard features. There are now camcorders on multiple-use devices such as mobile telephones and other such portable devices. In this way, a user may use the video camera to capture video and sound at important events such as weddings, birthdays, and children's activities. Typically, a video camera has an internal microphone for capturing sound. The internal microphone is very convenient, and captures sound as received at the camera. However, the microphone may also pick up camera noise, such as motor noise, and also may pick up substantial ambient noise, making the sound from the target of interest seem in the background, or worse, fail to pick up the desired sound at all. This problem is complicated if the desired recordable sound is distant from the camcorder. For example, taking video at a birthday party in a public environment may capture the sound from competing nearby parties, as well as announcements being made over a public address system. These other sounds are not only distracting, but drown out the interesting sounds and speech of the target birthday party.

To overcome this deficiency, video photographers sometimes use directional microphones attached to the camcorder or remote microphones cabled back to their video camera. Directional microphones by nature have some distinct disadvantages. First, they are much more susceptible to wind noise due to the diaphragm being exposed on both sides. To overcome this, if a directional mic is being used outside or in a windy area, bulky foam windscreens are needed to cut down on air turbulence at the diaphragm. Secondly, directional microphones often do not have a flat frequency response, and respond differently to sources according to whether they are near or far. A directional microphone far away from a source may need to amplify the audio signal, and in effect amplify ambient noise in the general direction in which it is pointed. By placing a microphone near the point of interest, sound may be captured and ambient noise avoided.

A microphone placed on a lapel will have an often desired effect of making a person's voice sound deeper and fuller. However, using a remote wired microphone requires preplanning and a priori knowledge of where specific events will occur. In some cases, this may be acceptable, for example, when a birthday party is centered around a particular table. However, this is ineffective when the point of activity is not known in advance. Further, handling the remote wired microphone and cables are annoying, and may interrupt the flow of the party, for example, by tripping party guests.

In another attempt to solve the problem, video cameras have recently been introduced with wireless capability. These video cameras have built in standardized wireless technology or other technology radios, whether in the licensed range or otherwise, for communicating with a remote microphone. The remote microphone may then be positioned at the area of interest, and the acoustic information wirelessly transmitted back the camera. Many companies offer wireless microphone packages with options for the type of microphone, channels, battery, and receiver. The signal is transmitted wirelessly via radio waves of specific frequency. Two frequency bands are available; VHF (very high frequency), and UHF (ultra high frequency). UHF is preferred with a wider bandwidth due to the higher carrier frequency and more options for frequency settings, and therefore, multichannel capability. Although fairly effective, most existing wireless microphones are aimed at professional or prosumer videographers as the cost is prohibitive to most camcorder devices. Most of these devices utilized the frequency range of about 900 MHz for several reasons, including cost, availability, interference avoidance, and/or range. However, because most of these devices demand ultra high fidelity, because of cost and/or design, are not suitable for most consumer use. 900 MHz devices are also prone to interference, due to the prevalence of other devices in this frequency band, including cellular phones and repeaters, and cordless phones. Conventional 900 MHz audio transceiver are typically not created under a standard and are usually unforgiving with power consumption, because the transmitter is always on, usually on a single frequency. The other alternative is also to mix and match different components, again being relatively unsuitable or inconvenient for consumer use.

During the preparation of this application, a new Bluetooth communication device was launched that requires the use of a new Bluetooth-enabled video camera. This camera has an integral Bluetooth receiver for receiving a signal from a remote microphone. Unfortunately, millions of video cameras are in use from different manufacturers, and it is unlikely that users will replace an entire camera system merely to obtain the benefits of a wireless microphone. In a slight modification of this configuration, some manufacturers have developed a proprietary input and output port through a hot shoe on specific models of video cameras. A receiver is constructed to mate with this proprietary set of connectors, and is able to communicate with a remote wireless microphone. However, such a proprietary system again requires the use of specific newly acquired camera equipment, and is not applicable to other models manufactured by that manufacturer, and certainly cannot be used on any other manufacturer's video camera. Accordingly, there exists a need for a flexible, convenient, and economical system for providing remote microphone support to legacy video cameras, lower end cameras or such devices from a multitude of sources.

### SUMMARY

Briefly, the present invention provides a wireless audio receiver that couples to a video camera using a standard audio connector, such as a 2.5 or 3.5 mm plug commonly found on consumer music playback devices. This enables a wide range of legacy and non-wireless video cameras to receive sound information through a wireless connection. The wireless audio receiver may be paired with a remote wireless microphone, and receive a wireless signal having sound information captured at the remote location. In one example, the wireless audio receiver is constructed with a Bluetooth compliant radio system. The wireless audio receiver may connected to an audio-in port of the camera using a connection cable, or the wireless audio receiver may be constructed so that the standard connector provides support for both mechanical and electrical connections.

In a more particular arrangement, the wireless audio receiver is able to pair with multiple wireless microphones, so that sound may be captured at two or more remote locations. Also, the wireless audio receiver may have a local microphone, as the built-in microphone of the video camera may be disabled when the wireless audio receiver is connected. In a more advanced construction, the wireless audio receiver may have sufficient processing capability to determine a direction of arrival for a received wireless signal. In this way, the sound information may be provided to the video camera with correct left-to-right positioning of the respective microphone. This may be accomplished using a small dual antenna array able to spatially locate multiple subjects in two dimensions by comparing the received signal strength.

Advantageously, the wireless audio receiver enables the use of a wireless remote microphones for a wide range of legacy video cameras, and for cameras not specifically manufactured for wireless conductivity.

### BRIEF DESCRIPTION OF THE DRAWINGS

FIG. 1 is a block diagram of a video camera system in accordance with the present invention.

FIG. 2 is a block diagram of a wireless audio receiver in accordance with the present invention.

FIG. 3 is a block diagram of a wireless remote microphone in accordance with the present invention.

FIG. 4 is a block diagram of a video camera system in accordance with the present invention.

FIG. 5 is a block diagram of a wireless audio receiver in accordance with the present invention.

FIG. 6 is a block diagram of a video camera system in accordance with the present invention.

### DETAILED DESCRIPTION OF THE PREFERRED EMBODIMENT

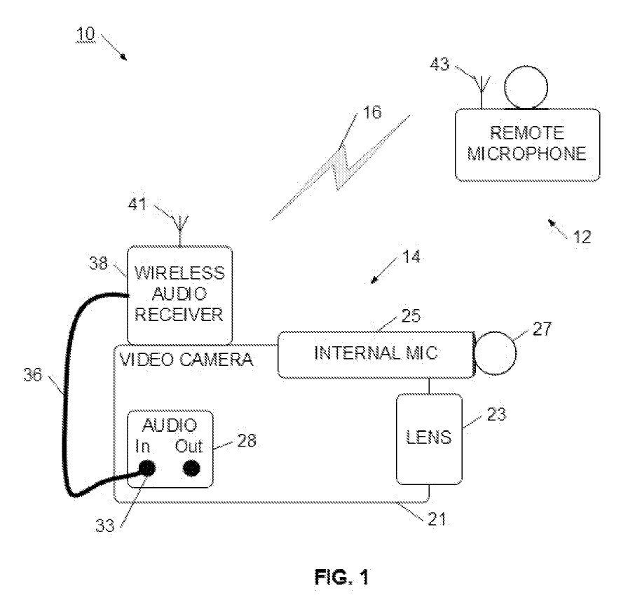

Referring now to FIG. 1, a video camera system 10 is illustrated. Camera system 10 includes a video camera 14. Video camera 14 is constructed as a standard video camera such as a minicam or portable camcorder. It will be appreciated that the construction of video cameras is well-known, and will not be described in detail herein. Video camera 14 has a body 21 which holds a lens 23 and a microphone system 25. Often, the internal microphone system 25 has a wind shield 27 or other covering over the opening to the microphone. The video camera typically has an audio connector area 28 having input 33 and output connections. These input and output connections are typically constructed according to standard mono or stereo input connectors. For example, many camcorders use have a standard female 2.5 mm mono or stereo connector for receiving an associated male connector. It will be appreciated that other standard analog or digital connectors may be substituted, and that the wireless receiver may be constructed to support more than one standard, such that the aim of an universal device is maintained.

Typically, when a connection line 36 is inserted with its connector into the audio input 33, the internal microphone system 25 is disabled. Instead of using an internal microphone system 25, video camera 14 uses a wireless audio receiver 38 to receive communications from remote microphone 12. Wireless audio receiver 38 has an antenna 41 for establishing communication 16 with the antenna and radio system 43 for the remote microphone 12. In one example, the communication is a Bluetooth communication, although it will be appreciated that other local or personal area network communication systems may be used. The wireless audio receiver 38 has a radio, such as a Bluetooth radio, for receiving communications from the remote microphone. The radio signal includes audio information collected by the remote microphone 12. The wireless audio receiver generates an analog or digital audio signal for transmission online 36 to the audio analog input port 33 for the video camera. In this way, the remote microphone 12 may be positioned near an activity of interest, and the sound from the activity wirelessly transmitted 16 to the wireless audio receiver 38. Using remote microphone 12, the video camera is better able to capture important audio activity at the point of interest.

For example, the remote microphone 12 may be constructed as a clip-on battery-powered microphone. Preferably, the microphone is a lavalier microphone, or a small microphone, either condenser or dynamic, which can be easily hidden in a piece of clothing so as not to be seen by the camera. Also referred as a peanut, the portable microphone can hook around the neck or is clipped to clothing. Such microphones are also known as a necklace, lapel, or pendant microphone. The microphone can record in stereo or in mono. In this way, remote microphone 12 may be attached to, for example, a child having a birthday party. Since birthday parties often occur in high ambient noise locations, it may be difficult to capture the child's speaking voice using an internal microphone 25. However, since the remote microphone 12 is attached to the child, that child's voice may be accurately and much more clearly captured by remote microphone 12. The local sounds from remote microphone 12 are converted to digital signals, and cooperate with a Bluetooth radio to transmit the audio signal to the wireless audio receiver, where it is passed to the video camera through the audio-in port. Importantly, the wireless audio receiver and remote microphone system may be used with any video camera having a standard audio-in port. In this way, no changes need to be made to the video camera itself, and the wireless audio receiver and remote microphone may operate on a wide range of legacy cameras, or cameras not manufactured to have or be compatible with wireless receivers. Typically, the audio jack on the video camera, aka camcorder, is an analog 2.5 or 3.5 mm female input jack. It will be appreciated that other legacy jack standards may exist and be substituted.

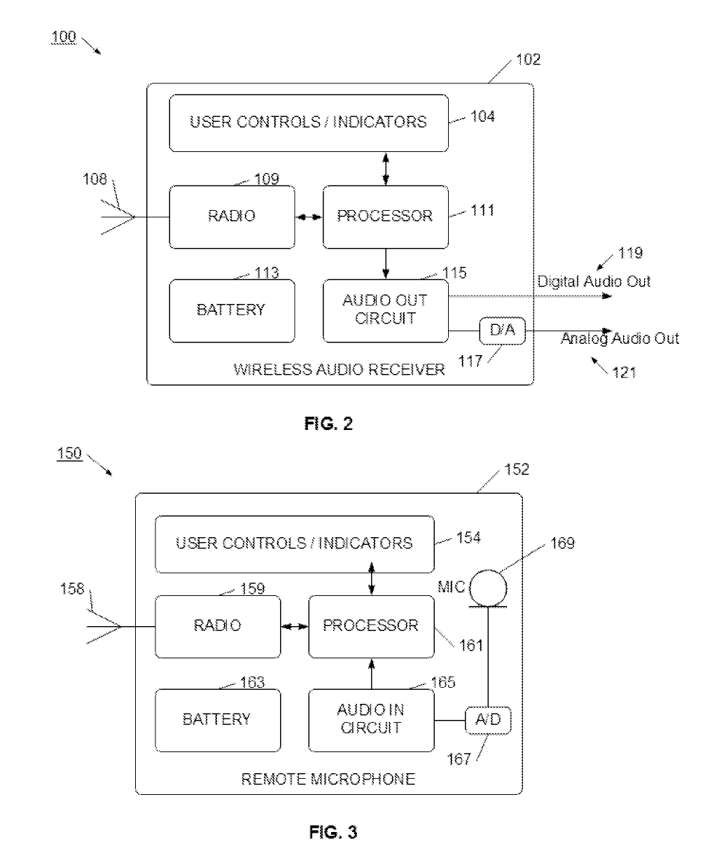

Referring now to FIG. 2, a block diagram 100 is illustrated for a wireless audio receiver 102. Wireless audio receiver 102 is similar to wireless audio receiver 38 generally describe with reference to FIG. 1. Wireless audio receiver 102 has an antenna 108 for receiving communications from a remote microphone. Further, the antenna 108 may be used to send commands, instructions, or other information to the remote microphone to assist in microphone setup. The antenna 108 couples to a radio 109, which may be, for example, a Bluetooth radio system. The radio contains a Bluetooth chip or chipset for communicating with a second Bluetooth chip or chipset. However, it will be appreciated that other wireless technologies may be used as described below.

Bluetooth (aka IEEE 802.15.1) is a radio standard primarily designed for low power consumption, with a short range and with a low-cost transceiver microchip in each device (see, e.g., www.bluetooth.com for specifications and standards information). Currently, products are available in one of three power classes dictating range, Class 1 100 mW 20 dBm ˜100 meters, Class 2 2.5 mW 4 dBm ˜10 meters, and Class 3 1 mW 0 dBm ˜10 cm (1 meter max) (power class dependent: 10 centimeters, 10 meters, 100 meters). In addition, there are different specifications according to the Bluetooth standards, including V1.0, V1.2 and V2.0, with V2.0 having introduced Enhanced Data Rate (EDR) of 2.1 Mbit/s for higher end audio data transmission. Additional standards, including the standard currently code named Lisbon, or such other standards (in power or specification) that is introduced by the Bluetooth Special Interest Group (SIG), is also contemplated In a preferred embodiment, the present invention employs Class 1 and/or Class 2 devices employing the V2.0 or higher specification to enable high fidelity transmission. In its most preferred embodiment, in order to conserve power consumption, the device is manually or automatically capable of switching between Class 1 and Class 2.

The Bluetooth transceiver operates in the 2.4 GHz ISM band. The Bluetooth spectrum ranges from 2.4000 GHz to 2.4835 GHz, thus yielding 83.5 MHz of allocated bandwidth which includes a 2 MHz lower guardband, a 3.5 MHz upper guard band and 781 MHz channels in the available 78 MHz between the guardbands for communications. Bluetooth operates using frequency hopping spread spectrum, where data packets are spread and efficiently packaged across the Bluetooth Spectrum at a nominal rate of 1,600 hops per second in a pseudorandom fashion followed by both the transmitter and receiver to lessen interference, fading, and intersymbol interference as well as increase security and decrease power consumption.

The provided description has specific details for a thorough understanding of, and enabling description for embodiments of the invention. However, one skilled in the art will understand that the invention may be practiced without these details. In other instances, well known structures and functions have not been shown or described in detail to avoid unnecessarily obscuring the description of the embodiments of the invention. While aspects of the invention are described herein as employing the Bluetooth protocol, those skilled in the relevant art will recognize that aspects of the invention are equally applicable with other communication protocols and standards, including those encompassing other short range wireless networks such as IEEE 802.11, contactless smart cards, IrDA standards, Home RF, etc. However, because of its low cost financially and in power consumption, as well as its standardization and other such features, Bluetooth is a desirable protocol for the present invention.

Another desirable standard may be Zigbee, which is a specification communication protocol designed for use in small, low-power radios based on the IEEE 802.15.4 standard for wireless personal area networks (WPANs). This standard specifies operation in the unlicensed 2.4 GHz, 915 MHz and 868 MHz ISM bands, where currently the-air data rate is 250 kbit/s per channel in the 2.4 GHz band, 40 kbit/s per channel in the 915 MHz band, and 20 kbit/s in the 868 MHz band. Transmission range is between 10 and 75 meters (33˜246 feet). Because of its low cost financially and in power consumption, as well as its standardization and other such features, Bluetooth and Zigbee are desirable protocols for the present invention. Depending on the rate of data transmission, Bluetooth may be more desirable for transmitting higher fidelity audio signals (e.g., @ 44 kHz), whereas for lower audio transmission such as 8 or 12 kHz transmission at around 16 bits (suitable for voice signals, although higher and lower are acceptable), Zigbee may be sufficient. Bluetooth chips or chipsets can be attained from a number of sources including from such semiconductor companies as Samsung, Texas Instrument, CSR, Broadcom, Motorola, Nokia, Erickson and numerous others.

The radio cooperates with a processor 111 to convert the radio signal to a baseband audio signal. For example, preprocessor 111 may have modulation, demodulation, filtering, signal processing, or other functions useful for processing audio data. The processor may also accept instructions from user controls 104. In one example, the user may set a relative volume for the remote microphone, or may even turn the remote microphone off. It will be appreciated that a wide range of user controls may be used.

The processor 111 may also send signals to indicators 104 for informing the user of status. For example, the remote microphone may have a low battery indicator which is wirelessly transmitted to the wireless audio receiver. In this way, a lamp or audio indicator may be set to indicate that the remote microphone is running low on power. Such an indication would allow a video camera operator to refresh the batteries in remote microphone prior to the remote microphone running out of power. It will be appreciated that many other indicators may be used. The audio signal is passed to an audio out circuit 115. In some cases, the audio out may be a digital audio out signal 119, while in other cases it may be an analog audio out 121. In the case of an analog audio out, a D to A converter 117 may be used to convert the digital signal provided by the audio out circuit 115 into an analog audio signal 121. The audio analog output 121 may have a communication line with a standard mono or stereo plug. In a similar manner, the digital audio output 119 may also have a connector for standard digital audio connectors.

The wireless audio receiver 102 also has battery 113 which may be, for example, a rechargeable battery. Wireless audio receiver 102 may also have a DC power input, for receiving power from a power converter or other local powered device. For example, some video photographers use large battery packs for powering local lighting or other accessories, these battery packs often have additional power outlets, which may be used to power the wireless audio receiver 102. Alternatively, smaller rechargeable or replaceable batteries or power sources may be employed because of the low power consumption of the devices.

Referring now to FIG. 3, a remote microphone 152 is illustrated. Remote microphone 152 is similar to remote microphone 12 described with reference to FIG. 1. Remote microphone 152 has an antenna 158 for establishing communication with a wireless audio receiver. The antenna 158 may transmit audio information signals to the wireless audio receiver, as well as sending and transmitting receiving instruction or command information. Antenna 158 couples to radio 159, which may be, for example, a Bluetooth radio.

Multiple antennas can be employed in the present invention. Multiple antennas can be employed to create an array of information paths for such use as locating the remote microphone device. Given multiple antennas, the spatial dimension can be exploited to improve the performance of the wireless link. By locating the direction of the remote microphone device, a stereo effect can be overlayed on the audio signal path into the camcorder. In addition, the multi-path multiplexing, or multiple input multiple output (MIMO) techniques, MIMO algorithms in a radio chipset can send information out over two or more antennas to create and take advantage of multi-paths by multiplexing the signals to boost the signals, increase system capacity and improve resistance to interference.

The radio 159 cooperates with processor 161 to receive instructions and transmit audio signals. A microphone 169 is positioned to capture local acoustic signals, and pass those signals to an A to D convert 167. The A to D converter converts the analog microphone signal to a digital data stream. It will be appreciated that filtering and processing may also be applied along with the A to D conversion. The digital data stream is received in an audio in circuit 165, which may further process the audio information. The audio information is passed to processor 161, where it is prepared for transmission on radio 159 through antenna 158. Local user controls and indicators 154 may also couple to processor 161 for receiving input from a user, as well as providing indicators to the user. The remote microphone 152 is powered by a battery system 163. The battery may also have a new charging circuit so that rechargeable batteries may be used. In another example, the battery 163 may include a DC input for accepting connection to a power converter coupled to household power.

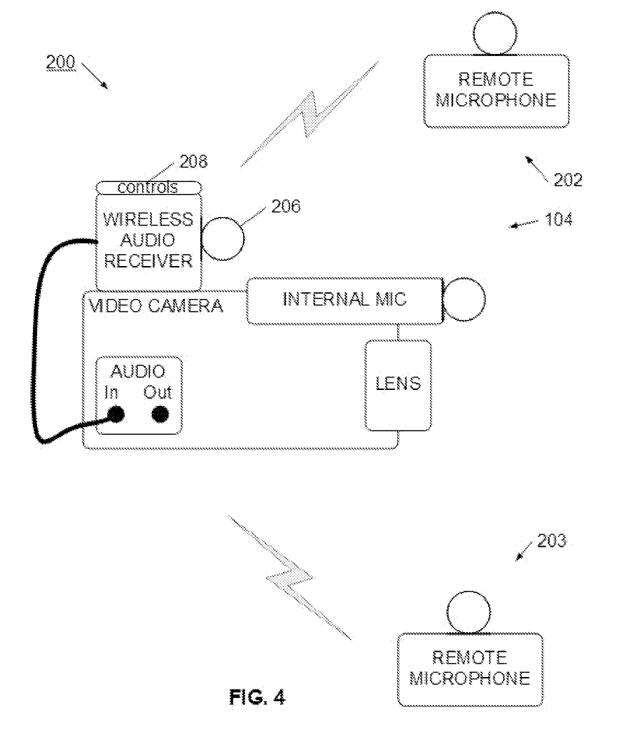

Referring now to FIG. 4, a video camera system 200 is illustrated. Video camera system 200 has a video camera 104 and a remote microphone 202. The video camera 104 is similar to video camera 14 previously described, so will not be described in detail, and remote microphone 202 is similar to remote microphone 12 described earlier, so will not be described in detail. However, video camera system 200 has a wireless audio receiver 202 having a local microphone 206. In this way, the wireless audio receiver may capture ambient noise around the camera, as well as capture noise at one or more remote microphones such as remote microphone 202. Controls 208 may allow the operator to set a relative volume between the various microphones, or may allow the operator to selectively activate or deactivate microphones. In this way, a user is given control over whether to capture acoustic information at remote microphones, at the local camera, or a combination of both. Video camera system 200 also may support multiple remote microphones. For example, a remote microphone 203 may be positioned at a different location, or may be attached to a different person. It will be appreciated that multiple remote microphones may be used in this manner. Multiple remote microphones may also be employed to enable the ability to switch between them at the receiver, either manually or automatically. In a manual process, the camcorder may have a selection switch, button, or other selection means for allowing the user to selectively activate one or more wireless microphones. The user could activate a button or control and switch from one wireless microphone to another wireless microphone, perhaps with a fade-out feature. In an automatic process, may be desirable at, say, a wedding where a videographer could place microphones at a number of places in a room and the camera would automatically switch between them depending on where the camera is pointed. Such an automated feature would work well with security cameras also—a camera could pan depending upon some motion sensing feedback, and automatically select a microphone in the area to record.

It may also be possible that the wireless audio receiver 208 is constructed with sufficient intelligence to calculate a direction of arrival from the remote microphones. Accordingly, provided the audio input is a stereo input, the wireless audio receiver may properly place the sound for remote microphone in the left to right channel. For example, the local microphone 206 may generally acquire ambient noise for the background, and acts to drive center channel information. Sound coming from each microphone may be positioned more left or more right depending upon the location detected by the wireless audio receiver 208. By enabling direction of arrival information, a more realistic reproduction may be enabled.

It may be also possible to artificially add additional sound effects to the audio signal. In general, analog inputs are recorded in mono or stereo. If in stereo, effects such as left/right balance and depth/fade can be added. For example, by employing multiple microphones on the wireless transmitter, stereo effects can be created. Alternatively, or in addition, microphones on the receiver, stereo or mono, depth or fade can be perceived based on the level of noise input to both the receive microphones and the transmitter microphones.

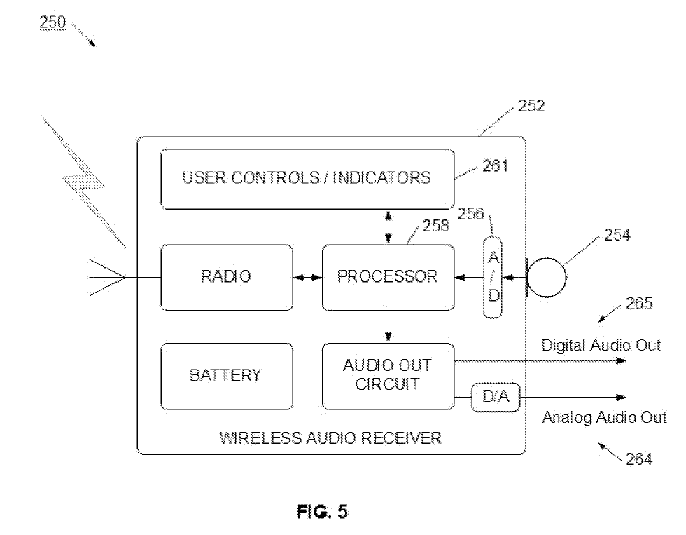

Referring now to FIG. 5, a wireless audio receiver 250 is illustrated. Wireless audio receiver 250 is similar to wireless audio receiver 208 illustrated with reference to FIG. 4. The wireless audio receiver 252 may receive wireless audio information as previously described, but may also capture local audio information using a local microphone 254. The local microphone 254 couples to an A to D converter 256 for converting an audio analog signal to a digital data stream. It will be appreciated that other filtering and preprocessing processes may be applied to the audio signal. The audio signal from the microphone 254 is combined with any audio signal received through the radio system, and passed to the audio out circuit. The relative volume between the local microphone 254 and any remote microphone may be adjusted using user controls 261. In another example, the processor 258 may receive or calculate direction of arrival information from the remote microphones, and may act to generate a signal where the remote acoustic signal is appropriately positioned left to right with in the audio signal. The audio out circuit then prepares either a digital audio out 265, or prepares an analog audio out signal 264. The audio out signals may then use standard connectors to couple to a video camera.

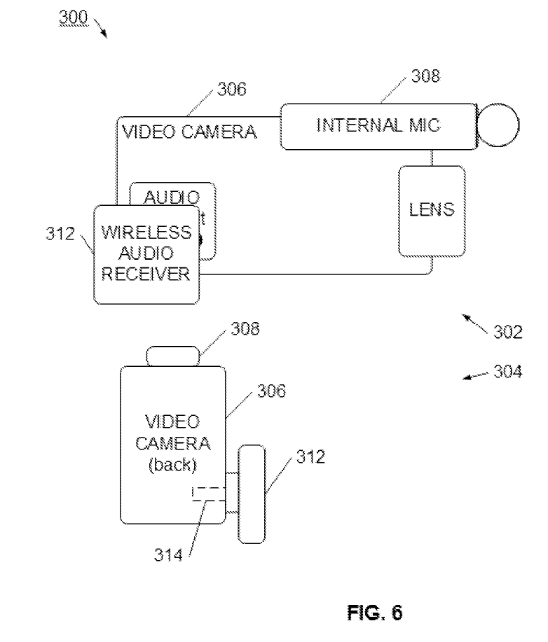

Referring now to FIG. 6, a video camera system 300 is illustrated. Video camera 300 has a video camera body 306 having internal microphone 308 and lens system. The video camera system 300 also has a wireless audio receiver 312 that functions similarly to wireless audio receivers previously described. However, the wireless audio receiver 312 is physically constructed to directly attach to the audio connector of the video camera. In this way, the wireless audio receiver 312 is mechanically attached to video camera 306 using standard connector 314. The standard connector 314 also acts to electrically couple the wireless audio receiver to the acoustic and audio circuitry within the video camera. FIG. 6 shows a side view 302 of the camera as well as a back view of the camera 304. It will be appreciated that various alternatives of the wireless audio receiver 312 may be made dependent on the particular configuration of video camera 306. Although having a combined electrical and mechanical connection as described with reference to FIG. 6 may provide certain convenience and ease of use, the connection through an audio line as previously described may provide more flexibility and may provide support for a wider range of cameras.

A wireless audio receiver may mechanically attach to a video camera in a wide variety of ways. For example, a wireless audio receiver may have cooperating hook and loop material to detach and reconnect the wireless audio receiver to the video camera. In another example, the wireless audio receiver 38 may mechanically attach to a hot shoe or other attachment mechanism on the video camera, while the electrical or audio connection is made through a standard legacy jack.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

What is claimed is:

1. A wireless microphone system for a video camera, comprising:
a remote microphone generating a wireless signal indicative of sound captured at a remote location;
a wireless audio receiver receiving the wireless signal and generating a standard audio signal; and
a standard connector connected to the wireless audio receiver and selected to couple to a standard audio-in port of a video camera.

2. The wireless microphone system according to claim 1, wherein the remote microphone generates a Bluetooth compliant wireless signal, and the wireless audio receiver includes a Bluetooth radio for receiving the Bluetooth wireless signal.

3. The wireless microphone system according to claim 1, wherein the wireless audio receiver further comprises a local microphone.

4. The wireless microphone system according to claim 1, wherein the wireless audio receiver further comprises a processor for determining direction of arrival of the wireless signal.

5. The wireless microphone system according to claim 1, wherein the standard connector is directly attached to the wireless audio receiver and is constructed to provide mechanical attachment to the video camera.

6. The wireless microphone system according to claim 1, wherein the standard connector is coupled to the wireless audio receiver with a cable.

7. The wireless microphone system according to claim 1, wherein the standard connector is one selected from the group consisting of: 3.5 mm male audio connector, 2.5 mm male, and their respective female counterparts.

8. The wireless microphone system according to claim 1, further comprising a second remote microphone generating another wireless signal indicative of sound captured at another remote location.

9. The wireless microphone system according to claim 1, wherein the remote microphone is constructed to generate an low-battery signal and communicate the low battery signal using the wireless signal, and the wireless audio receiver is constructed to set an alarm indicative of the low battery signal.

10. The wireless microphone system according to claim 1, wherein the alarm is an audio alarm or a visual alarm

11. The wireless microphone system according to claim 1, wherein the remote microphone generates a Zigbee compliant wireless signal, and the wireless audio receiver includes a Zigbee radio for receiving the Zigbee wireless signal.

12. A wireless audio receiver for a video camera, comprising:
a radio constructed to establish communication with a remote microphone;
a processor for generating a standard audio signal; and
a standard connector connected to the wireless audio receiver and selected to couple to a standard audio-in port of a video camera.

13. The wireless audio receiver according to claim 12, wherein the radio is a Bluetooth compliant radio.

14. The wireless audio receiver according to claim 12, wherein the wireless audio receiver further comprises a local microphone.

15. The wireless audio receiver according to claim 12, wherein the processor is constructed to determining direction of arrival of a wireless signal.

16. The wireless audio receiver according to claim 12, wherein the standard connector is directly attached to the wireless audio receiver and is constructed to provide mechanical attachment to the video camera.

17. The wireless audio receiver according to claim 12, wherein the standard connector is coupled to the wireless audio receiver with a cable.

18. The wireless audio receiver according to claim 12, wherein the standard connector is one selected from the group consisting of: 3.5 mm male audio connector, 2.5 mm male, and their respective female counterparts.

19. The wireless audio receiver according to claim 12, further including user controls for receiving user input.

20. The wireless audio receiver according to claim 12, further including user indicators for providing information to the user.

21. The wireless audio receiver according to claim 12, wherein the radio is constructed to be compliant with the Zigbee communication standard.
